(19) United States
(12) Patent Application Publication
(10) Pub. No.: US 2025/0109624 A1
(43) Pub. Date: Apr. 3, 2025

(54) DRAWER-TYPE SAFE

(71) Applicant: NINGBO ANSOL CABINET CO., LTD., Ningbo (CN)

(72) Inventor: Limin Yuan, Ningbo (CN)

(21) Appl. No.: 18/801,516

(22) Filed: Aug. 12, 2024

(30) Foreign Application Priority Data
Sep. 28, 2023 (CN) 2023226717918

(51) Int. Cl. E05G 1/02; E05G 1/06

(52) U.S. Cl. CPC E05G 1/02; E05G 1/06

(57) ABSTRACT

A drawer-type safe comprises a safe body, wherein a front side of the safe body is an open structure, a cabinet door is hingedly mounted on a front right side of the upper and lower inner walls of the safe body, a password lock locking mechanism is fixedly mounted on the cabinet door, and the password lock locking mechanism is locked and fixed to a left side wall of the safe body, drawer bodies are installed between a left inner wall and a right inner wall of the safe body through connecting mechanisms. This invention, through the adoption of the pull-out drawer structure, provides greater convenience for storing and retrieving items; the entire process is visually accessible, eliminating the need for strenuous bending or squatting; furthermore, multiple upper and lower drawers facilitate categorized storage.

### 1. TECHNICAL FIELD

The invention relates to the technical field of safes, in particular to a drawer-type safe.

### 2. BACKGROUND ART

A safe is a special type of container. Based on its functions, it is mainly classified into fireproof safes, anti-theft safes, anti-magnetic safes, fireproof and anti-magnetic safes, and fireproof and anti-theft safes, and so on. Each type of safe has its own national standard. Most safes available on the market belong to the first two categories. Depending on the different working principles of passwords, anti-theft safes (or boxes) can be further divided into mechanical safes and electronic safes. The former is characterized by its relatively low price and reliable performance.

In prior art, the safes available on the market are mostly conventional, consisting of a safe body that includes a cabinet and a door. The space enclosed by steel plates inside the cabinet is used to store items. Due to the heavy weight of most safes, they are typically placed on the ground or at a low position close to the ground. This results in the need to bend down significantly or even squat to access the contents inside, and the presence of shelves further obstructs the view. Accessing items stored in the lower layers is even more inconvenient. Additionally, the deep depth of most safes leads to poor lighting inside, making it difficult to clearly see and retrieve items. Overall, It is very inconvenient to access items in safes placed at low positions.

### 3. SUMMARY OF THE INVENTION

The invention provides a drawer-type safe to solve the problems in the background technology.

In order to achieve the above objects, the invention provides the following technical scheme: the drawer-type safe, comprising a safe body, wherein a front side of the safe body is an open structure, a cabinet door is hingedly mounted on a front right side of the upper and lower inner walls of the safe body, a password lock locking mechanism is fixedly mounted on the cabinet door, and the password lock locking mechanism is locked and fixed to a left side wall of the safe body, drawer bodies are installed between a left inner wall and a right inner wall of the safe body through connecting mechanisms, the connecting mechanisms comprise drawer brackets and drawer guide rails, two drawer brackets are provided, and the drawer brackets are fixedly installed on the left and right inner walls of the safe body respectively, the drawer guide rails are movably mounted on the facing sides of drawer brackets in snap-fit connections, or the drawer guide rails are fixed on the facing sides of the drawer brackets by riveting or screws, each pair of left and right drawer guide rails are fixedly installed on left and right sides of one drawer body.

Further, by disassembling and assembling the drawer guide rails, the drawers can be disassembled and assembled.

Further, the number of drawers can be one or two or more, and the drawer bodies can be arranged vertically and uniformly by tightly fitting the upper and lower sides of adjacent drawer bodies, or arranged at intervals.

Further, the drawer guide rails can also be sliding grooves, guide rails, or guide telescopic structures.

Further, fixed brackets can be used to fix the drawer guide rails, or the drawer guide rails can be made into a guiding groove structure that matches the drawers.

Further, handles are mounted on front sides of the drawer bodies.

Further, an inner periphery of the safe body is provided with a stop edge, and the stop edge is made into a dead edge structure.

Further, a battery box is arranged on the password lock locking mechanism, and a password setting key is installed on the password lock locking mechanism.

Compared with the prior art, the invention provides the drawer-type safe, which has the following advantageous effects:
this drawer-type safe, through the adoption of the pull-out drawer structure, provides greater convenience for storing and retrieving items; the entire process is visually accessible, eliminating the need for strenuous bending or squatting; furthermore, the multiple upper and lower drawers facilitate categorized storage, negating the hassle of having to remove top layers of items to access those beneath, fully utilizing space; the items stored in the drawers enjoy an extra layer of protection, preventing access through drilling through the sidewalls of the safe body; the presence of relatively enclosed drawer bodies provides an additional barrier, which is akin to a double-walled safe, enhancing the anti-theft performance of the safe.

### 4. BRIEF DESCRIPTION OF ACCOMPANY DRAWINGS

FIG. 1 is a schematic diagram of the structure of the invention;

FIG. 2 is a top sectional view of the invention.

In the figures: 1 safe body; 2 cabinet door; 3 password lock locking mechanism; 4 connecting mechanism; 401 drawer bracket; 402 drawer guide rail; 5 drawer body; 6 handle; 7 stop edge; 8 password setting key; 9 battery box.

### 5. SPECIFIC EMBODIMENT OF THE INVENTION

The technical schemes in the embodiments of the invention will be clearly and completely described in combination with the accompanying drawings in the embodiments of the invention. Obviously, the described embodiments are only some of the embodiments of the invention, but not all of the embodiments. Based on the embodiments in this invention, all other embodiments obtained by those of ordinary skill in the art without making creative efforts shall fall within the protection scope of this invention.

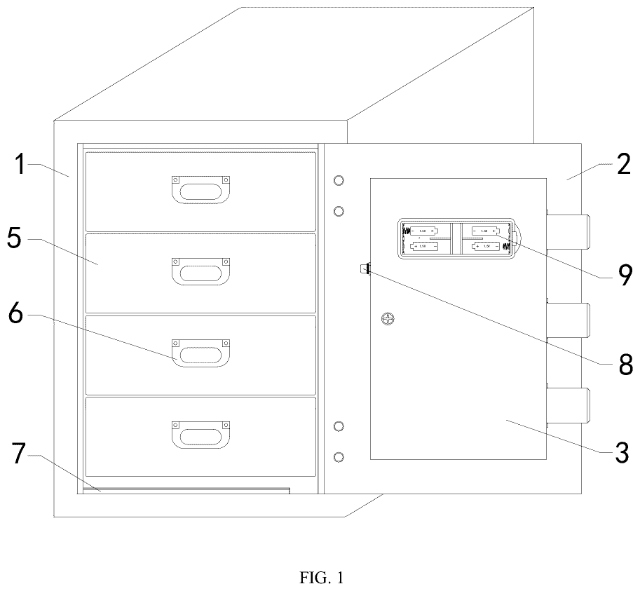

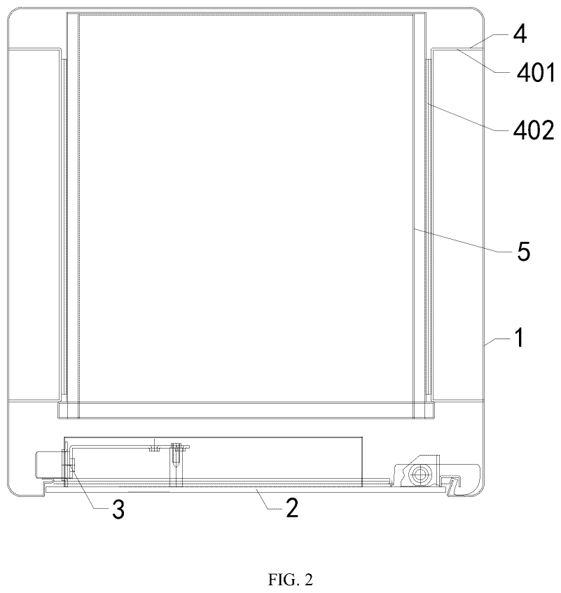

Please refer to FIG. 1 and FIG. 2, the invention provides the drawer-type safe, comprising a safe body 1, wherein a front side of the safe body 1 is an open structure, a cabinet door 2 is hingedly mounted on a front right side of the upper and lower inner walls of the safe body 1, a password lock locking mechanism 3 is fixedly mounted on the cabinet door 2, and the password lock locking mechanism 3 is locked and fixed to a left side wall of the safe body 1, drawer bodies 5 are installed between a left inner wall and a right inner wall of the safe body 1 through connecting mechanisms 4, the connecting mechanisms 4 comprise drawer brackets 401 and drawer guide rails 402, two drawer brackets 401 are provided, and the drawer brackets 401 are fixedly installed on the left and right inner walls of the safe body 1 respectively, the drawer guide rails 402 are movably mounted on the facing sides of drawer brackets 401 in snap-fit connections, each pair of left and right drawer guide rails 402 are fixedly installed on left and right sides of one drawer body 5.

Specifically, handles 6 are mounted on front sides of the drawer bodies 5.

In this scheme, the handles 6 facilitate the pulling of the drawer bodies 5, that is, facilitate the opening and closing of the drawer bodies 5.

Specifically, an inner periphery of the safe body 1 is provided with a stop edge 7, and the stop edge 7 is made into a dead edge structure.

In this scheme, the stop edge 7 can limit the cabinet door 2, so that the cabinet door 2 does not interfere with the drawer bodies 5 after being locked; lower side walls of the drawer bodies 5 have a grid structure with a mesh diameter of 1 mm.

In this scheme, the lower side walls of the drawer bodies 5 are designed to meet the requirement of not interfering with the pull-out function, facilitating the everyday use of the drawer body 5.

Specifically, a battery box 9 is arranged on the password lock locking mechanism 3, and a password setting key 8 is installed on the password lock locking mechanism 3.

In this scheme, the battery box 9 is used for battery installation, providing power to the password lock locking mechanism 3. After the password setting key 8 is touched, the password can be set to operate the opening and closing of the cabinet door 2.

Specifically, four drawer bodies 5 are evenly arranged vertically, and upper and lower sides of adjacent drawer bodies 5 are closely fitted together.

In this scheme, the items stored in the drawer bodies 5 are not easy to fall out at will, and the storage is safe.

During use, the drawer guide rails 402 and drawer brackets 401 in the connecting mechanisms 4 are connected via a movable snap-fit, enabling the drawer bodies 5 to move back and forth on the drawer brackets 401 through the drawer guide rails 402; this forms a pull-out drawer structure, making it more convenient to access and store items in the drawer bodies 5; the entire process is visually accessible, eliminating the need for strenuous bending or squatting; furthermore, the multiple upper and lower drawers facilitate categorized storage, negating the hassle of having to remove top layers of items to access those beneath, fully utilizing space; the items stored in the drawers enjoy an extra layer of protection, preventing access through drilling through the sidewalls of the safe body 1; the presence of relatively enclosed drawer bodies 5 provides an additional barrier, which is akin to a double-walled safe, enhancing the anti-theft performance of the safe; in addition, the stop edge 7 can limit the cabinet door 2 to avoid interfering with the drawer bodies.

In summary, this drawer-type safe, through the adoption of the pull-out drawer structure, provides greater convenience for storing and retrieving items; the entire process is visually accessible, eliminating the need for strenuous bending or squatting; furthermore, the multiple upper and lower drawers facilitate categorized storage, negating the hassle of having to remove top layers of items to access those beneath, fully utilizing space; the items stored in the drawers enjoy an extra layer of protection, preventing access through drilling through the sidewalls of the safe body 1; the presence of relatively enclosed drawer bodies 5 provides an additional barrier, which is akin to a double-walled safe, enhancing the anti-theft performance of the safe.

Although the embodiments of the invention have been shown and described above, it should be understood that those skilled in the art can make changes, modifications, substitutions and alterations to the above embodiments without departing from the principles and spirit of the invention. The scope of the invention is defined by the claims and their equivalents.

1. A drawer-type safe, comprising a safe body, wherein a front side of the safe body is an open structure, a cabinet door is hingedly mounted on a front right side of the upper and lower inner walls of the safe body, a password lock locking mechanism is fixedly mounted on the cabinet door, and the password lock locking mechanism is locked and fixed to left side wall of the safe body, drawer bodies are installed between left inner wall and right inner wall of the safe body through connecting mechanisms, the connecting mechanisms comprise drawer brackets and drawer guide rails, two drawer brackets are provided, and the drawer brackets are fixedly installed on the left and right inner walls of the safe body respectively, the drawer guide rails are movably mounted on the facing sides of the drawer brackets in snap-fit connections, or the drawer guide rails are fixed on the facing sides of the drawer brackets by riveting or screws, each pair of left and right drawer guide rails are fixedly installed on left and right sides of one drawer body.

2. The drawer-type safe of claim 1, wherein the drawers are disassembled and assembled by disassembling and assembling the drawer guide rails.

3. The drawer-type safe of claim 1, wherein number of drawers is one or two or more, and the drawer bodies are arranged vertically and uniformly by tightly fitting the upper and lower sides of adjacent drawer bodies, or arranged at intervals.

4. The drawer-type safe of claim 1, wherein drawer guide rails are sliding grooves, guide rails, or guide telescopic structures.

5. The drawer-type safe of claim 1, wherein handles are mounted on front sides of the drawer bodies.

6. The drawer-type safe of claim 1, wherein an inner periphery of the safe body is provided with a stop edge, and the stop edge is made into a dead edge structure.

7. The drawer-type safe of claim 1. wherein a battery box is arranged on the password lock locking mechanism, and a password setting key is installed on the password lock locking mechanism.
